(19) United States
(12) Patent Application Publication
(10) Pub. No.: US 2024/0292484 A1
(43) Pub. Date: Aug. 29, 2024

(54) METHOD PERFORMED BY USER EQUIPMENT AND USER EQUIPMENT

(71) Applicant: SHARP KABUSHIKI KAISHA, Sakai City, Osaka (JP)

(72) Inventors: CHONGMING ZHANG, Shanghai (CN); SHOHEI YAMADA, Sakai City, Osaka (JP)

(21) Appl. No.: 18/573,011

(22) PCT Filed: Jul. 6, 2022
(86) PCT No.: PCT/CN2022/104118

§ 371 Date: Dec. 21, 2023

(30) Foreign Application Priority Data
Jul. 9, 2021 (CN) 202110781875.X

(51) Int. Cl. H04W 76/27; H04W 76/19; H04W 88/04

(52) U.S. Cl. CPC H04W 76/27; H04W 76/19; H04W 88/04

(57) ABSTRACT

Provided in the present invention are a method performed by user equipment and user equipment. The method comprises the following steps: remote UE initiating an RRC connection resume process, and determining whether there is a PC5 RLC entity for SRB1; and if there is no PC5 RLC entity for SRB1, the remote UE establishing a PC5 RLC entity for SRB1; or, if there is a PC5 RLC entity for SRB1, the remote UE re-establishing the PC5 RLC entity, and further determining whether the re-established PC5 RLC entity corresponds to a current serving relay UE, or corresponds to a destination address targeting the current serving relay, wherein, if no correspondence is found, the remote UE associates the re-established PC5 RLC entity with the current serving relay UE, or associates same with the destination address targeting the current serving relay.

### TECHNICAL FIELD

The present invention relates to the technical field of wireless communications. More specifically, the present invention relates to a method for RLC in a sidelink relay architecture performed by user equipment, and corresponding user equipment.

### BACKGROUND

At the 3rd Generation Partnership Project (3GPP) RAN #80 plenary meeting in June 2018, the subject of the study on the feasibility of V2X based on 5G NR network technology of Release 16 (see non-patent literature: RP-181480, New SID Proposal: Study on NR V2X) was approved. The primary function included in NR V2X of Release 16 is to support unicast, multicast, and broadcast in out-of-coverage and in-coverage scenarios.

At the RAN #86 plenary meeting in December 2019, a study item on NR sidelink relaying of Release 17 was proposed (see non-patent literature: RP-193253, New Study Item on NR Sidelink Relaying), and was approved. Regarding the latest release of the study item, see non-patent literature: RP-201474, Revised SID: NR Sidelink Relay. The study item mainly studies the solution to user equipment (UE)-to-network and UE-to-UE relaying, for extending sidelink-based coverage. One of the goals of the study item is to support a sidelink control plane procedure.

At the RAN #91 plenary meeting in March 2020, a study item on NR sidelink relaying of Release 17 was proposed (see non-patent literature: RP-210904, New Study Item on NR Sidelink Relaying), and was approved. One of the goals of the work item is to standardize a sidelink control plane procedure, such as management of an RRC connection.

UE may establish an RRC connection to a base station via relay UE. Such UE may be referred to as remote UE. The remote UE and the relay UE communicate with each other via sidelink, and a sidelink communication interface is a PC5 interface. The relay UE and the base station still use a Uu interface for communication therebetween.

After the remote UE establishes an RRC connection with the base station via the relay UE, a PC5 RLC entity for SRB1 corresponds to a current serving relay UE (denoted as relay UE-A).

When the remote UE receives an RRC connection release message carrying suspension information and transmitted by the base station, the UE suspends SRB1, re-establishes an RLC entity for SRB1, and then enters an RRC INACTIVE state.

The UE may initiate an RRC connection resume process to re-enter an RRC connected state.

Before the UE enters the connected state, the UE may perform relay reselection, that is, the current serving relay (denoted as relay UE-B) is no longer relay UE-A.

But the relay UE to which the PC5 RLC entity for SRB1 corresponds is still relay UE-A, as a result, the remote UE will be unable to receive an SRB1 message transmitted by the base station and cannot communicate with the base station normally.

### SUMMARY

In order to address the aforementioned issue, the present invention provides a method performed by user equipment and user equipment.

According to an aspect of the present invention, provided is a method performed by user equipment, being a method performed by remote UE and relay UE in an RRC connection management process, comprising the following steps:
the remote UE initiating an RRC connection resume process, and determining whether a PC5 RLC entity for SRB1 is present, and
if there is no PC5 RLC entity for SRB1, then the remote UE establishing a PC5 RLC entity for SRB1, or
if there is a PC5 RLC entity for SRB1, then the remote UE re-establishing the PC5 RLC entity, and further determining whether the re-established PC5 RLC entity corresponds to a current serving relay UE, or corresponds to a destination address targeting the current serving relay, wherein,
if the re-established PC5 RLC entity does not correspond to the current serving relay UE, or does not correspond to a destination address targeting the current serving relay, the remote UE associates the re-established PC5 RLC entity with the current serving relay UE, or is associated with the destination address targeting the current serving relay.

According to an aspect of the present invention, provided is a method performed by user equipment, being a method performed by remote UE and relay UE in an RRC connection management process, comprising the following steps:
the remote UE initiating an RRC connection resume process, and determining whether a PC5 RLC entity for SRB1 is present, and
if there is no PC5 RLC entity for SRB1, then the remote UE establishing a PC5 RLC entity for SRB1, or
if there is a PC5 RLC entity for SRB1, then the remote UE determining whether the relay UE to which the PC5 RLC entity corresponds is the current serving relay UE, or whether the destination address to which the PC5 RLC entity corresponds to the current serving relay UE, wherein,
if the relay UE to which the PC5 RLC entity corresponds is not the current serving relay UE, or if the destination address to which the PC5 RLC entity corresponds does not correspond to the current serving relay UE, then the remote UE releases the PC5 RLC entity and establishes a PC5 RLC entity for SRB1, or re-establishes the PC5 RLC entity.

In the above-described method performed by user equipment, preferably,
the PC5 RLC entity established by the remote UE corresponds to the current serving relay UE, or corresponds to the destination address targeting the current serving relay, and
the PC5 RLC entity re-established by the remote UE is associated with the current serving relay UE, or is associated with the destination address targeting the current serving relay.

In the foregoing method performed by user equipment, preferably, the following steps are further comprised:
the remote UE receiving an RRC connection release message from the base station, the message carrying suspension configuration information; and
the remote UE releasing the PC5 RLC entity for SRB1 on the basis of the received suspension configuration information.

In the above-described method performed by user equipment, preferably,
in the case where relay reselection occurs,
if the remote UE is in an inactive state, the remote UE releases the PC5 RLC entity for SRB1 and establishes a PC5 RLC entity for SRB1, and the PC5 RLC entity corresponds to a selected relay UE, and
if the remote UE is in an idle state, the remote UE does not perform the above operation.

In the above-described method performed by user equipment, preferably,

When the remote UE initiates an RRC connection resume process, the remote UE further performs the following operation:
re-establishing a PDCP entity for SRB1;
establishing a PC5 RLC entity for SRB1; or
resuming SRB1.

In the above-described method performed by user equipment, preferably,
Establishment of an RLC entity at least includes:
   establishing an RLC entity; and
   setting a state variable of the RLC entity to an initial value.
Re-establishment of an RLC entity at least includes:
discarding all RLC SDUs, RLC SDU segments, RLC PDUs,
   stopping and resetting all timers; and
   resetting the state variable of the RLC entity to an initial value.

In the above-described method performed by user equipment, preferably,

In the operation of establishing or re-establishing an RLC entity, a default configuration is applied to the PC5 RLC entity, and the default configuration is a default configuration for transmission of SRB1 on the PC5 interface.

According to another aspect of the present invention, user equipment is provided, comprising:
a processor; and
a memory storing instructions,
the instructions, when run by the processor, causing the user equipment to perform the method described above.

The method performed by user equipment and the corresponding user equipment involved in the present invention can realize normal communication with a base station.

### BRIEF DESCRIPTION OF THE DRAWINGS

FIG. 1 is a schematic diagram showing UE-to-network relay.

FIG. 2 is a schematic diagram showing control plane protocol stacks of a UE-to-network L2 architecture.

FIG. 3 is a flowchart showing a method performed by UE.

FIG. 4 is a flowchart showing another method performed by UE.

FIG. 5 is a simplified structural block diagram of user equipment (UE) according to the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, please see the latest 3GPP standards and specifications.
RedCap: Reduced Capability
UE: User Equipment
NR: New Radio
MAC: Medium Access Control
MAC CE: MAC control element
RLC: Radio Link Control
SDAP: Service Data Adaptation Protocol
PDCP: Packet Data Convergence Protocol
RRC: Radio Resource Control
RRC_CONNECTED: RRC connected state
RRC_INACTIVE: RRC inactive state
RRC_IDLE: RRC idle state
RAN: Radio Access Network
Sidelink: sidelink communication
SCI: Sidelink Control Information
AS: Access Stratum
IE: Information Element
CE: Control Element
MIB: Master Information Block
NR: New Radio
SIB: System Information Block
NG-RAN: NG Radio Access Network
DCI: Downlink Control Information
ADAPT: adaptation layer
PHY: physical layer
RB: Radio Bearer
DRB: Data Radio Bearer
SRB: Signaling Radio Bearer
PDU: Protocol Data Unit
SDU: Service Data Unit
V2X: Vehicle-to-Everything
CCCH: Common Control Channel
DCCH: Dedicated Control Channel

In the present invention, a network, a base station, and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, user equipment (UE) may refer to an NR device that supports an NR sidelink relay function as described in the background, may also refer to an NR device that supports an NR sidelink relay architecture, and may also refer to an NR device or an LTE device of another type.

In the present invention, sidelink and PC5 may be used interchangeably, and an RLC channel, an RLC entity, and an RLC bearer may be used interchangeably.

Hereinafter, a description will be given of related art of the present invention.

A PC5 interface is an interface for performing control plane and user plane sidelink communication between UE and UE. For sidelink unicast, a PC5-RRC connection is an AS layer logical connection between a pair of a source layer-2 ID and a target layer-2 ID. Setup of one PC5 unicast link corresponds to setup of one PC5-RRC connection.

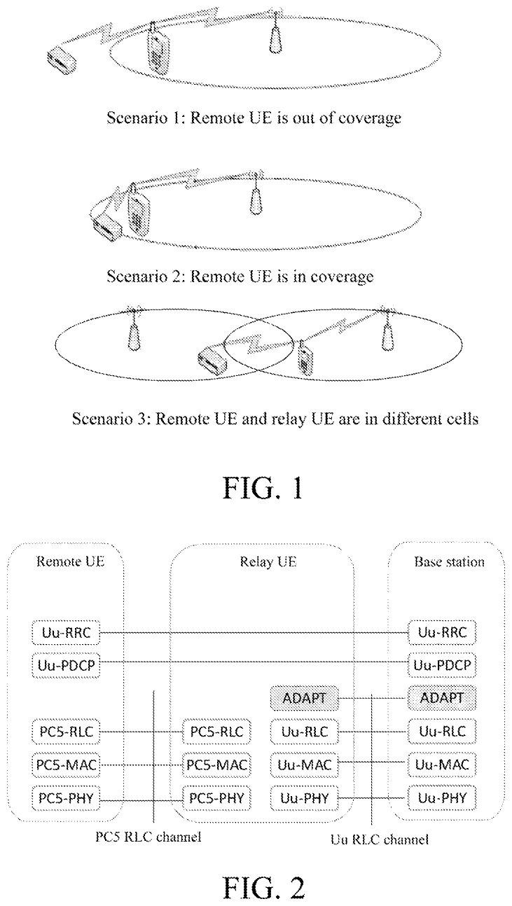

UE-to-network relaying is as shown in FIG. 1. In scenario 1 and scenario 2, the left side is remote UE, the middle is relay UE, and the right side is a network. In scenario 3, both sides are networks, and the middle, from left to right, is remote UE and relay UE, respectively. The remote UE and the relay UE are connected to each other by means of a PC5 interface, and the relay UE is connected to the network by means of a Uu interface. Because the remote UE is far from the network or because the communication environment is poor, the relay UE is needed to relay and forward signaling and data between the remote UE and the network.

UE-to-network relay scenarios include:
1) the remote UE is out of coverage, and the relay UE is in coverage;
2) the remote UE and the relay UE are both in coverage, and are in the same cell; and
3) the remote UE and the relay UE are both in coverage, but are in different cells.

For a sidelink layer-2 (L2) relay architecture, control plane protocol stacks of remote UE, relay UE, and a base station are as shown in FIG. 2.

After the remote UE selects one piece of relay UE to provide a relay service for the remote UE, the remote UE will establish a PC5-RRC connection to the relay UE, so as to communicate with the network by means of the relay UE. The remote UE can establish an air interface RRC connection to the network via the relay UE for data transmission between the remote UE and the network. The remote UE encapsulates, via the Uu PDCP layer, data of messages to the network for air interface RRC connection setup, re-establishment, resume, etc., and then submits same to a PC5 RLC entity to be further encapsulated, borne on a PC5 RLC channel, and submitted downwards layer by layer via PC5-MAC and PC5-PHY. Upon receiving the data carrying the message, the relay UE submits same upwards layer by layer via PC5-PHY and PC5-MAC. The relay UE finds, via a mapping relationship between a PC5 RLC channel and a Uu RLC channel, the Uu RLC channel bearing the message, encapsulates the message in a Uu message/data, and transmits same to the network. In turn, an RRC message returned by the network is encapsulated by the base station in a Uu message/data and transmitted to the relay UE. The relay UE finds, via a mapping relationship between a PC5 RLC channel and a Uu RLC channel, the PC5 RLC channel bearing the message, encapsulates the message in a PC5 message/data, and transmits same to the remote UE. When the remote UE initiates procedures such as RRC connection establishment, re-establishment, and resume to the network, in order to be capable of correctly transmitting data when needed and promptly stopping data transmission when not needed, Uu RLC/MAC and PC5 RLC/MAC also need to be subjected to corresponding processing. In turn, the network may also release and suspend, to the remote UE, an air interface RRC connection by means of the relay UE, and in the foregoing procedures, Uu RLC/MAC and PC5 RLC/MAC also need to be subjected to corresponding processing.

### SRB0 Message

Over the Uu interface, the UE transmits an RRC connection setup request message, an RRC connection re-establishment request message, and an RRC connection resume request message to the base station via SRB0. SRB0 is for RRC messages using the CCCH logical channel. It can be seen that the RRC connection setup request message, the RRC connection re-establishment request message, and the RRC connection resume request message are all RRC messages using the CCCH logical channel. Herein, the RRC message transmitted on SRB0 may simply be referred to as an SRB0 message.

### SRB1 Message

Over the Uu interface, the UE transmits an RRC connection resume request message to the base station via SRB0. The base station may transmit an RRC connection resume message as a response message to the UE via SRB1. Alternatively, the UE transmits an RRC connection re-establishment request message to the base station via SRB0. The base station may transmit an RRC connection re-establishment message as a response message to the UE via SRB1. SRB1 is for RRC messages using the DCCH logical channel. It can be seen that the RRC connection resume message and the RRC connection re-establishment message are all RRC messages using the CCCH logical channel. Herein, the RRC message transmitted on SRB1 may simply be referred to as an SRB1 message.

### PC5 Interface

A wireless communication interface between remote UE and relay UE. The remote UE and the relay UE communicate with each other via sidelink, and a sidelink communication interface is a PC5 interface. Therefore, the description of the sidelink and the description of PC5 are interchangeable herein.

The PC5 RLC entity refers to an RLC entity for PC5 interface communication.

### Uu Interface

A wireless communication interface between UE and a base station. The UE may communicate with eNB over the Uu interface by using an E-UTRAN. The UE may also communicate with gNB over the Uu interface by using NR.

The Uu RLC entity refers to an RLC entity for Uu interface communication.

In essence, the PC5 RLC entity and the Uu RCL entity both refer to an RLC entity that follows an RLC protocol stack, but are used for different communication interfaces.

According to the present invention, remote UE and relay UE may correctly process PC5 RLC and Uu RLC in a procedure related to an air interface RRC connection between the remote UE and a base station, thereby achieving correct setting of variables of the RLC layer in procedures such as air interface RRC connection setup, ensuring the correctness of data transmission, and avoiding a procedure exception.

Hereinafter, several embodiments of the present invention for addressing the above problems are described in detail.

### Example 1

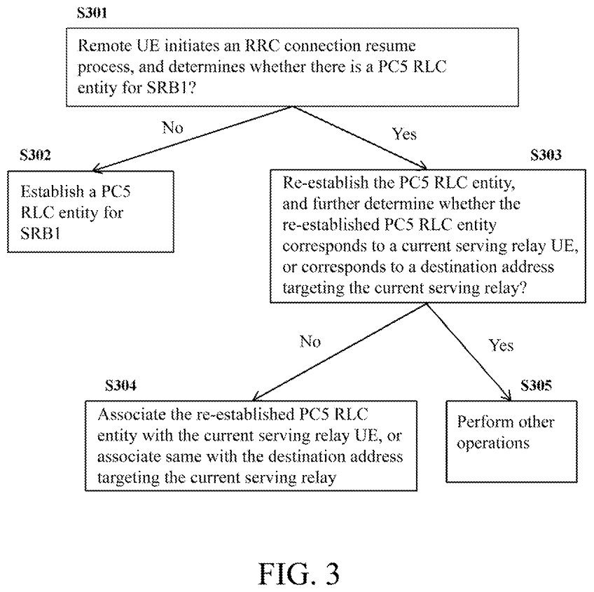

Provided in the present example is a method performed by UE, being a method performed by remote UE and relay UE in an RRC connection management process. As shown in FIG. 3, the method includes the following steps:

Step S301: remote UE initiating an RRC connection resume procedure (process).

In this process, the remote UE determines whether there is a PC5 RLC entity for SRB1:
if the determination result indicates that there is no PC5 RLC entity for SRB1 (a negative determination result is obtained in step S301), then the remote UE establishes a PC5 RLC entity for SRB1 (step S302), and preferably, the PC5 RLC entity corresponds to a current serving relay UE, or corresponds to a destination address targeting the current serving relay;
if the determination result indicates that there is a PC5 RLC entity for SRB1 (an affirmative determination result is obtained in step S301), then the remote UE may re-establish the PC5 RLC entity, and, preferably, continue to determine whether the PC5 RLC entity corresponds to the current serving relay UE, or corresponds to the destination address targeting the current serving relay (step S303):
   if the determination result indicates that the PC5 RLC entity does not correspond to the current serving relay UE, or does not correspond to the destination address targeting the current serving relay (a negative determination result is obtained in step S303), then the PC5 RLC entity is caused to be associated with the current serving relay UE (or is caused to be associated with the destination address targeting the current serving relay) (step S304);
   if the determination result indicates that the PC5 RLC entity corresponds to the current serving relay UE (an affirmative determination result is obtained in step S303), then other operations are performed (step S305).

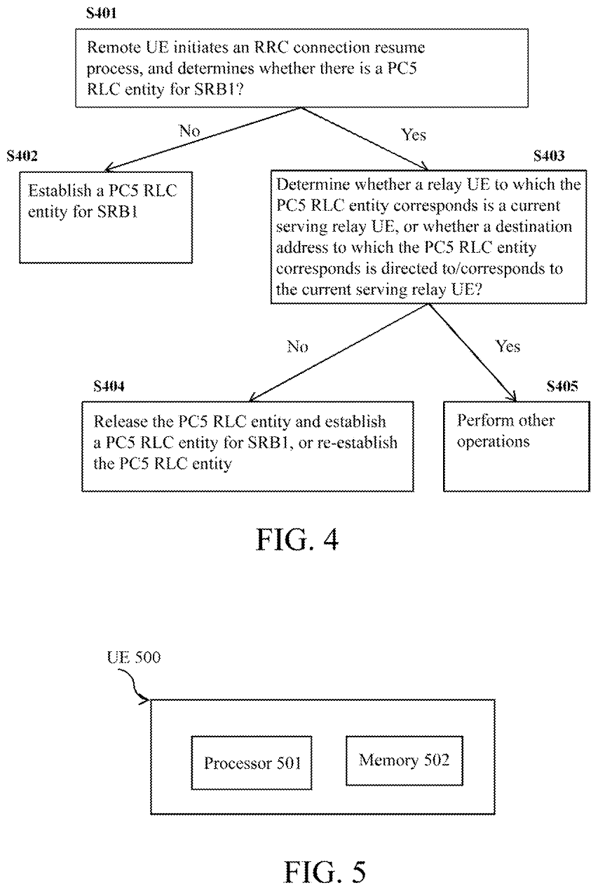

Another implementation of the above solution may be as follows, as shown in FIG. 4, the method performed by UE includes the following steps.

Step S401: remote UE initiating an RRC connection resume procedure (process).

In this process the remote UE determines whether there is a PC5 RLC entity for SRB1:
if the determination result indicates that there is no PC5 RLC entity for SRB1 (a negative determination result is obtained in step S401), then the remote UE establishes a PC5 RLC entity for SRB1 (step S402), and preferably, the PC5 RLC entity corresponds to a current serving relay UE, or corresponds to a destination address targeting the current serving relay;
if the determination result indicates that there is a PC5 RLC entity for SRB1 (an affirmative determination result is obtained in step S401), then the remote UE determines whether the relay UE to which the PC5 RLC entity corresponds is the current serving relay UE, or whether the destination address to which the PC5 RLC entity corresponds is directed to/corresponds to the current serving relay UE (step S403):
   if the relay UE to which the PC5 RLC entity corresponds is not the current serving relay UE (or the destination address to which the PC5 RLC entity corresponds is not directed to/corresponds to the current serving relay UE) (a negative determination result is obtained in step S403),
   the remote UE may release the PC5 RLC entity and establish a PC5 RLC entity for SRB1, and preferably, the PC5 RLC entity corresponds to the current serving relay UE, or corresponds to the destination address targeting the current serving relay; or
the remote UE may also re-establish the PC5 RLC entity, and preferably associate the PC5 RLC entity with the current serving relay UE (or associate same
   with the destination address targeting the current serving relay) (step S404).

In the case that the relay UE to which the PC5 RLC entity corresponds is the current serving relay UE (or the destination address to which the PC5 RLC entity corresponds is directed to/corresponds to the current serving relay UE) (an affirmative determination result is obtained in step S403), then other operations are performed (step S405).

Preferably, after the remote UE has completed performing the above determination and corresponding operations, the remote UE resumes SRB1.

Preferably, before the remote UE performs the above determination and corresponding operations, the remote UE re-establishes a PDCP entity for SRB1.

Preferably, when the remote UE performs the above determination and corresponding operations, a default configuration is applied to the PC5 RLC entity, and the default configuration may be a default configuration for transmission of SRB1 on the PC5 interface.

Such configuration information may include at least an RLC entity mode, a priority of the logical channel, a logical channel group number, etc. For example, the value of the RLC entity mode is the acknowledged mode (AM). The value of the priority of the logical channel is 1. The value of the logical channel group number is 0. On the basis of such configuration information, the relay UE may establish an RLC entity/bearer and a logical channel that uses such configuration information.

### Example 2

Remote UE may establish a specific sidelink SRB/DRB, which is used to bear an SRB1 message, or to bear a message transmitted using a logical channel of a dedicated logical channel category (e.g., a DCCH), or is used for SRB1 transmission via relay. Such sidelink SRB/DRB may be referred to as RB-X.

Therefore, an implementation may be as follows:

The remote UE initiates an RRC connection resume procedure (process).

In this process, the remote UE determines whether RB-X has been established:
if the determination result indicates that there is no RB-X, then the remote UE establishes RB-X, and preferably, RB-X corresponds to a current serving relay UE, or corresponds to a destination address targeting the current serving relay;
if the determination result indicates that RB-X is present, then the remote UE may re-establish a PDCP entity for RB-X, and to re-establish an RLC entity for RB-X, and preferably, after the PDCP and the RLC entity have been re-established, RB-X corresponds to the current serving relay UE, or corresponds to the destination address targeting the current serving relay.

Another implementation may be as follows:

The remote UE initiates an RRC connection resume procedure (process).

In this process, the remote UE determines whether RB-X has been established:
if the determination result indicates that there is no RB-X, then the remote UE establishes RB-X, and preferably, RB-X corresponds to a current serving relay UE, or corresponds to a destination address targeting the current serving relay;
if the determination result indicates that RB-X is present, then the remote UE may further continue to determine whether RB-X corresponds to the current serving relay UE, or corresponds to the destination address targeting the current serving relay:
   if the determination result indicates that RB-X does not correspond to the current serving relay UE, or does not correspond to the destination address targeting the current serving relay, the remote UE re-establishes an RLC entity for RB-X, and preferably, associates RB-X with the current serving relay UE (or with the destination address targeting the current serving relay); alternatively, the remote UE releases the PC5 RLC entity for RB-X, establishes a new PC5 RLC entity, and preferably, causes RB-X or the PC5 RLC entity for RB-X to correspond to the current serving relay UE, or correspond to the destination address targeting the current serving relay;
   if the determination result indicates that the entity for RB-X corresponds to the current serving relay UE, then other operations are performed.

Preferably, after the remote UE has completed performing the above determination and corresponding operations, the remote UE resumes RB-X.

Preferably, before the remote UE performs the above determination and corresponding operations, the remote UE re-establishes a PDCP entity for RB-X.

Preferably, when the remote UE performs the above determination and corresponding operations, a default configuration is applied to the PC5 RLC entity, and the default configuration may be a default configuration for transmission of SRB1 on the PC5 interface.

Such configuration information may include at least an RLC entity mode, a priority of the logical channel, a logical channel group number, etc. For example, the value of the RLC entity mode is the acknowledged mode (AM). The value of the priority of the logical channel is 1. The value of the logical channel group number is 0. On the basis of such configuration information, the relay UE may establish an RLC entity/bearer and a logical channel that uses such configuration information.

### Example 3

Remote UE receives an RRC connection release message from a base station, and the message carries suspension configuration information.

On the basis of the received suspension configuration information,
the remote UE releases a PC5 RLC entity for SRB1.

Alternatively, the remote UE releases RB-X.

Alternatively, the remote UE releases an RLC entity for RB-X, and suspends RB-X.

### Example 4

According to the signal quality or a measured level value between relay UE and remote UE, the remote UE may reselect a relay UE, that is, relay reselection occurs.

If the remote UE is in an INACTIVE state, then the remote UE releases the PC5 RLC entity for SRB1. Optionally, the remote UE establishes a PC5 RLC entity for SRB1, and the PC5 RLC entity corresponds to a selected relay UE.

If the remote UE is in an IDLE state, then the remote UE does not perform the above operations.

Another implementation of the foregoing solution may be as follows:

When the remote UE performs relay reselection, if the remote UE is in the INACTIVE state, then the remote UE releases the PC5 RLC entity for SRB1. Optionally, a PC5 RLC entity is established for SRB1, and the PC5 RLC entity corresponds to a selected relay UE.

### Example 5

On the basis of Example 3 or 4, when the remote UE initiates an RRC connection resume procedure, one or more of the following operations are performed:
re-establishing a PDCP entity for SRB1
establishing a PC5 RLC entity for SRB1;
resuming SRB1;
re-establishing a PDCP entity for RB-X;
establishing an RLC entity for RB-X; and
resuming RB-X.

### Example 6

In the operations of the foregoing example,

Establishment of an RLC entity may at least include:
establishing an RLC entity; and
setting a state variable of the RLC entity to an initial value.

Re-establishment of an RLC entity may at least include:
discarding all RLC SDUs, RLC SDU segments, and RLC PDUs;
stopping and resetting all timers; and
resetting the state variable of the RLC entity to an initial value.

### Example 7

In the operations of the foregoing example, the operation of establishing or re-establishing an RLC entity may further include applying a default configuration for the PC5 RLC entity, and the default configuration may be a default configuration for transmission of SRB1 on the PC5 interface.

### Example 8

In addition to an RRC connection resume procedure/process, the operations of the foregoing examples may also be performed in an RRC connection re-establishment process.

For example, the remote UE in Example 1 or 2 initiating an RRC connection resume procedure (process) and the remote UE initiating an RRC connection resume procedure (process) may be replaced with the remote UE initiating an RRC connection re-establishment procedure (process).

FIG. 5 is a simplified structural block diagram of user equipment (UE) according to the present invention. As shown in FIG. 5, user equipment (UE) 500 includes a processor 501 and a memory 502. The processor 501 may include, for example, a microprocessor, a microcontroller, an embedded processor, and the like. The memory 502 may include, for example, a volatile memory (such as a random access memory (RAM)), a hard disk drive (HDD), a non-volatile memory (such as a flash memory), or other memories. The memory 502 stores program instructions. The instructions, when run by the processor 501, can perform the above method performed by user equipment as described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. User equipment (UE), comprising:
a processor; and
a memory in electronic communication with the processor,
wherein instructions stored in the memory are executable to:
initiate a Radio Resource Control (RRC) connection re-establishment procedure, in which a Packet Data Convergence Protocol (PDCP) is re-established for a Signaling Radio Bearer 1 (SRB1);
(i) in a case where there is no sidelink (SL) Radio Link Control (RLC) entity associated with the SRB1, establish a SL RLC entity for the SRB1, or (ii) otherwise, release the SL RLC entity and establish a SL RLC entity for the SRB1;
apply a default configuration used for SRB1 transmission to the SL RLC entity for the SRB1; and
resume the SRB1.

12. A method performed by user equipment (UE), the method comprising:
initiating a Radio Resource Control (RRC) connection re-establishment procedure, in which a PDCP is re-established for a Signaling Radio Bearer 1 (SRB1);
(i) in a case where there is no sidelink (SL) Radio Link Control (RLC) entity associated with the SRB1, establishing a SL RLC entity for the SRB1, or (ii) otherwise, releasing the SL RLC entity and establish the SL RLC entity for the SRB1;
applying a default configuration used for the SRB1 transmission to the SL RLC entity for the SRB1; and
resuming the SRB1.
